(19) United States
(12) Patent Application Publication
(10) Pub. No.: US 2023/0224633 A1
(43) Pub. Date: Jul. 13, 2023

(54) EARFIT TEST METHOD AND DEVICE

(71) Applicant: HEAR LLC, Fairfax Station, VA (US)

(72) Inventor: John P. Keady, Fairfax Station, VA (US)

(73) Assignee: HEAR LLC, Fairfax Station, VA (US)

(21) Appl. No.: 18/096,549

(22) Filed: Jan. 12, 2023

Related U.S. Application Data
(60) Provisional application No. 63/298,977, filed on Jan. 12, 2022.
(60) Provisional application No. 63/308,552, filed on Feb. 10, 2022.
(60) Provisional application No. 63/308,564, filed on Feb. 10, 2022.

(51) Int. Cl. H04R 3/00; H04R 1/10; H04R 1/08

(52) U.S. Cl. CPC H04R 3/00; H04R 1/1008; H04R 1/08; H04R 1/1041

(57) ABSTRACT

At least one exemplary embodiment is directed to a method and a device to determine if an earplug or earpiece or earphone is properly sealed in a user's ear canal. Other embodiments can be used to determine blockages in a channel and determine the channels length.

### CROSS-REFERENCE TO RELATED APPLICATIONS

This application is a non provisional of and claims priority to U.S. Pat. App. No. 63/298,977, filed 12 Jan. 2022, U.S. Pat. App. No. 63/308,552, filed 10 Feb. 2022, and U.S. Pat. App. No. 63/308,564, filed 10 Feb. 2022, all the disclosures of which are incorporated herein by reference in their entirety.

### FIELD OF THE INVENTION

The present invention relates to determining the seal of inserted devices, and more particularly, though not exclusively, determining the seal quality of earplugs that can be inserted into an ear canal.

### BACKGROUND OF THE INVENTION

One of the current issues with hearing protection and hearing assistance systems is the ability of sealing to provide protection.

Current conventional systems use time consuming methods such as REAT and MIRE. Recent research using in-Field Real-Ear-Attenuation-at-Threshold (F-REAT) instrumentation has demonstrated that self-fitting of hearing protective premolded earplugs by military recruits, even after training in the fitting and use of the earplugs, resulted in a large percentage (about 35-40%) of them failing to meet a pre-determined criterion of desired spectral attenuation protection (Federman & Duhon, 2016). Follow-up tests after experimenter-fit of the earplugs showed significant improvements, particularly when 3-, 5-, and 7-frequency REAT testing was performed, and these attenuation improvements persisted after the subjects re-fit the earplugs on themselves, which was attributed to perceptual-learning effects termed “ear canal muscle memory.” This work clearly demonstrated the strong benefit of in-field fit test systems for training personnel to improve earplug fit, and thus their protection achieved, and it further highlighted the need for improving efficiency in these in-field fit-tests, both in time expended and number of frequencies tested (Federman & Duhon, 2016). Similar aspects of fit-testing efficiency efforts had been reported 25 years ago by Casali & Park (1992) for prediction of broad spectrum attenuation from a variety of single test frequencies, and again later by Lancaster & Casali (2005). Also, Ahroon (2019) performed a comprehensive round-robin evaluation of all commercially-available earplug fit-test systems including E-A-Rfit™, FitCheck™, HPD Well-Fit™, INTEGRAfit® and VeriPRO®, obtaining personal attenuation ratings (PARs) achieved by Army personnel, both before and after annual hearing tests. Ahroon (2019) concluded that all 5 systems tested were beneficial for earplug fit training purposes, and also were a better means of determining quality of fit than audiologist inspection alone. However, there was a wide variance of PAR values obtained on each earplug across the various systems, which indicates an effect of differences in protocols and/or instrumentation amongst the 5 systems. Nonetheless, Ahroon's results also lend support for further development and application of in-field, fit-test earplug systems for both earplug fit training and attenuation testing. These research studies, as well as others, have led the military hearing conservation community to the need for more efficient, more accurate, and more repeatable in-field, earplug fit-test systems that can evaluate multiple users at once with very efficient protocols—this is part and parcel of the aims of this SBIR.

Furthermore, there is a longstanding, overarching issue that EPA-required, in-laboratory, experimenter-fit REAT attenuation tests produce product-labeled attenuation performance that is optimum or nearly so, and which typically overestimates actual user self-fit attenuation performance in the field, often by significant amounts. While this labeled attenuation versus field attenuation discrepancy has been well-known for decades (e.g., Casali & Park, 1991; Berger, Franks, Behar, Casali, et al., 1998), there is no current federal or military requirement for in-field fit-testing to determine an individual's protected exposure levels (PELs) or personal attenuation ratings (PARs), nor has the EPA's labeling standard changed to yield attenuation data that more closely predict self-fit performance. Unfortunately, civil litigation has now just recently penetrated the hearing conservation industry in relation to the closely related issue of design and individual fit of HPDs, including military earplugs, with one example being the largest mass tort case in U.S. history now underway (U.S. District Court, 2022).

It is well-known that the attenuation provided by an HPD, and in particular an earplug, depends on a number of factors, including sound transmission loss (acoustic impedance) through the earplug material, resistance of the earplug to resonance in the ear canal, stability and retention of the earplug in the canal, reflection of noise by the external surface of the earplug, and most of all, the user's ability to obtain a noise-blocking seal against the ear canal walls with the product, in some cases comprising a pneumatic seal. It is this latter component that poses the dominant contribution to an earplug's overall attenuation, and it is the component of attenuation that is most affected by the quality of fit obtained by a user on himself or herself.

In 2018, a standard was developed, ANSI/ASA S12.71-2018, which stipulates performance criteria for systems that field-estimate an HPD's personal attenuation rating (PAR), which reflects the quality of fit obtained by the user in the field. As just mentioned above, the value of PAR will most heavily depend on the seal of an earplug being tested, and several methods such as the Real-Ear-Attenuation-Test (REAT) and Microphone-In-Real-Ear (MIRE) have been proposed to measure the seal of an HPD to obtain data for the PAR. Each of these methods has been extensively researched over many years (e.g., Casali, Mauney & Burks, 1995; Perala & Casali, 2009) and each suffers from several disadvantages. For instance, on a given subject who is fit with an earplug, the major issue is the time it takes to perform the tests, which is on the order of 20-60 minutes for either REAT or MIRE depending upon protocol used.

Furthermore, there is the strong possibility of compromising the integrity of the seal and/or structure of the HPD, particularly that of an earplug, with probe microphone wires or probe tubes required to be running through or around the earplug into the ear canal for MIRE. It is for this latter reason that ANSI S12.42-2010 specifically recommends against MIRE for earplug testing, even though some commercial MIRE fit-test systems do use “surrogate” (i.e., modified with a channel for the microphone) earplugs for this purpose.

A new, innovative means of HPD-fit-testing is needed for rapid verification of an earplug's seal. A method of easily and quickly providing a determinization of whether an earplug is sealed doesn't exist but would be useful.

### SUMMARY

An exemplary embodiment is directed to an Earplug Fit-Test System, comprised of an earmuff-based headphone device (also referred to as the LTM Headphone), the Fit-Test System can include, an internal microphone or multiple internal microphones and at least one speaker that fits above the inserted earplug, and provides a rapid fit/leak test (e.g., in just seconds). The Leak-Test Method (LTM) can use at least one internal microphone to measure test signals and determine directly or compare an unoccluded ear's acoustic spectrum to a ‘supposed’ occluded ear's acoustic spectrum to determine if a leak exists. The LTM process takes only seconds to yield a result, which will be indicative of whether an earplug seal leak of predetermined criterion is apparent, or not. If the LTM indicates a poor seal then the LTM Headphone is removed, the user repositions the inserted earplug or chooses a different one, reinserts, refits the tested earplug, then tests again using the rapid LTM feature, repeating the process until a good seal is indicated in each ear (since the test is performed bilaterally).

When the LTM indicates a good seal, then optionally, a Field Real-Ear-Attenuation-at-Threshold Test (FREAT), can be performed with the LTM Headphone.

### BRIEF DESCRIPTION OF THE DRAWINGS

Exemplary embodiments of present invention will become more fully understood from the detailed description and the accompanying drawings, wherein:

FIG. 1 illustrates a cartilaginous region and a bony region of an ear canal;

FIG. 2 illustrates general physiology of an ear;

FIG. 3 is a schematic diagram of a system for utilizing devices in accordance with the descriptions herein according to an embodiment of the present disclosure;

FIG. 4 is a schematic diagram of a machine in the form of a computer system within which a set of instructions, when executed, may cause the machine to perform any one or more of the methodologies or operations of the systems and methods for utilizing an LTM muff or headphone according to embodiments of the present disclosure;

FIG. 5 illustrates a LTM muff resting on head around an ear to be tested;

FIG. 6 illustrates a block diagram of some circuit components of the LTM muff shown in FIG. 5;

FIGS. 7A, 7B and 7C illustrates using the LTM muff to play audio content into an open ear (FIG. 7A), into a sealed ear (FIG. 7B), and into a leaky earplug system (FIG. 7C).

FIG. 8 illustrates spectral data of microphone signals for an earplug leak condition, an earplug sealed condition and an empty ear condition;

FIGS. 9A, 9B, 9C illustrates test fixture spectral data for an open ear where, P2=20 mm and ear canal length (P1-P2)=25 mm;

FIGS. 10A, 10B, 10C illustrates test fixture spectral data for an occluded (sealed) ear where, P2=20mm and ear canal length (P1-P2)=25mm;

FIGS. 11A, 11B, 11C illustrates test fixture spectral data for an 1.27 mm OD leak where, P2=20 mm and ear canal length (P1-P2)=25 mm; and

FIGS. 12A, 12B, 12C illustrates test fixture spectral data for occluded ear where, P2=20 mm and ear canal length (P1-P2)=25 mm, with a muff leak of 2 mm by 2 mm.

### DETAILED DESCRIPTION OF EXEMPLARY EMBODIMENTS

The following description of exemplary embodiment(s) is merely illustrative in nature and is in no way intended to limit the invention, its application, or uses.

Exemplary embodiments are directed to or can be operatively used on various passive earplugs for hearing protection or electronic wired or wireless earpiece devices (e.g., hearing aids, ear monitors, earbuds, headphones, ear terminal, behind the ear devices or other acoustic devices as known by one of ordinary skill, and equivalents). For example, the earpieces can be without transducers (for a noise attenuation application in a hearing protective earplug) or one or more transducers (e.g. ambient sound microphone (ASM), ear canal microphone (ECM), ear canal receiver (ECR)) for monitoring/providing sound. In all of the examples illustrated and discussed herein, any specific values should be interpreted to be illustrative only and non-limiting. Thus, other examples of the exemplary embodiments could have different values.

Processes, techniques, apparatus, and materials as known by one of ordinary skill in the art may not be discussed in detail but are intended to be part of the enabling description where appropriate. For example specific materials may not be listed for achieving each of the targeted properties discussed, however one of ordinary skill would be able, without undo experimentation, to determine the materials needed given the enabling disclosure herein.

Notice that similar reference numerals and letters refer to similar items in the following figures, and thus once an item is defined in one figure, it may not be discussed or further defined in the following figures. Processes, techniques, apparatus, and materials as known by one of ordinary skill in the relevant art may not be discussed in detail but are intended to be part of the enabling description where appropriate.

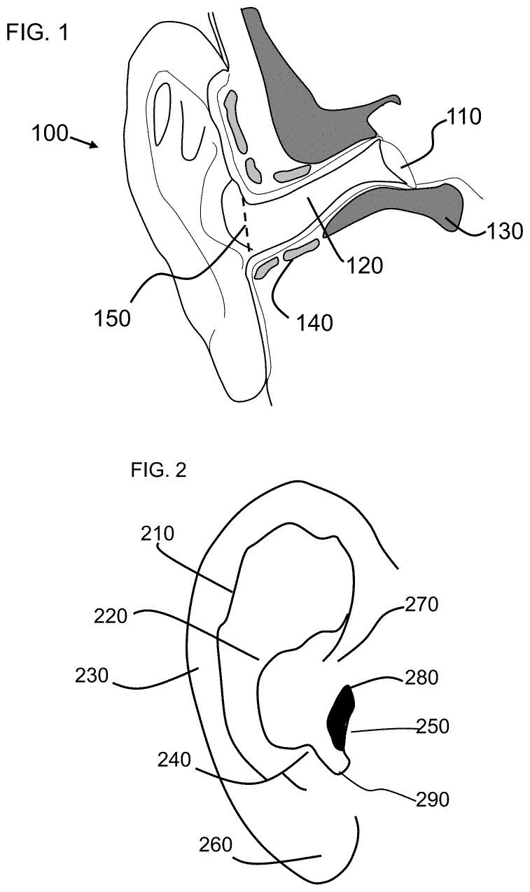

FIG. 1 illustrates a generic cross section of an ear canal 100, including a cartilaginous region 140 and a bony region 130 of an ear canal 120. The entrance of the ear canal 120 is referred to as the aperture 150 and defines a first end of the ear canal while the tympanic membrane 110 defines the other end of the ear canal 120.

FIG. 2 illustrates general outer physiology of an ear, which includes a, auricle tubercle 210, the antihelix 220, the helix 230, the antitragus 240, tragus 250, lobule of ear 260, crus of helix 270, anterior notch 280, and intertragic incisures 290.

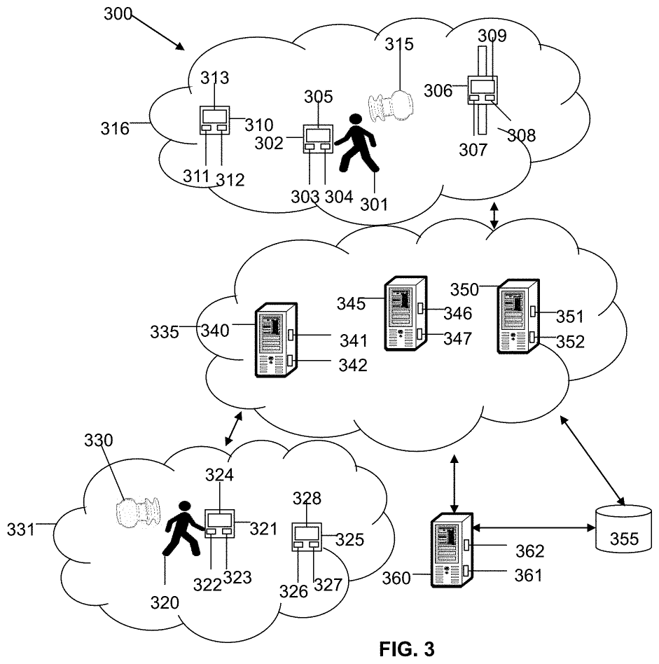

As shown in FIG. 3, a system 300 and methods for utilizing LTM headphone and/or earphone devices are disclosed.

The system 300 may be configured to support, but is not limited to supporting, data and content services, audio processing applications and services, audio output and/or input applications and services, applications and services for transmitting and receiving audio content, authentication applications and services, computing applications and services, cloud computing services, internet services, satellite services, telephone services, software as a service (SaaS) applications, platform-as-a-service (PaaS) applications, gaming applications and services, social media applications and services, productivity applications and services, voice-over-internet protocol (VoIP) applications and services, speech-to-text translation applications and services, interactive voice applications and services, mobile applications and services, and any other computing applications and services. The system may include a first user 301, who may utilize a first user device 302 to access data, content, and applications, or to perform a variety of other tasks and functions. As an example, the first user 301 may utilize first user device 302 to access an application (e.g. a browser or a mobile application) executing on the first user device 302 that may be utilized to access web pages, data, and content associated with the system 300. In certain embodiments, the first user 301 may be any type of user that may potentially desire to listen to audio content, such as from, but not limited to, a music playlist accessible via the first user device 302, a telephone call that the first user 301 is participating in, audio content occurring in an environment in proximity to the first user 301, any other type of audio content, or a combination thereof. For example, the first user 301 may be an individual that may be participating in a telephone call with another user, such as second user 320.

The first user device (e.g., computer, phone, tablet, watch, LTM headphone) 302 utilized by the first user 301 may include a memory 303 that includes instructions, and a processor 304 that executes the instructions from the memory 303 to perform the various operations that are performed by the first user device 302. In certain embodiments, the processor 304 may be hardware, software, or a combination thereof. The first user device 302 may also include an interface 305 (e.g. screen, monitor, graphical user interface, etc.) that may enable the first user 301 to interact with various applications executing on the first user device 302, to interact with various applications executing within the system 300, and to interact with the system 300 itself. In certain embodiments, the first user device 302 may include any number of transducers, such as, but not limited to, microphones, speakers, any type of audio-based transducer, any type of transducer, or a combination thereof. In certain embodiments, the first user device 302 may be a computer, a laptop, a tablet device, a phablet, a server, a mobile device, a smartphone, a smart watch, and/or any other type of computing device. Illustratively, the first user device 302 is shown as a mobile device in FIG. 3. The first user device 302 may also include a global positioning system (GPS), which may include a GPS receiver and any other necessary components for enabling GPS functionality, accelerometers, gyroscopes, sensors, and any other componentry suitable for a mobile device.

In addition to using first user device 302, the first user 301 may also utilize and/or have access to a second user device 306 and a third user device 310. As with first user device 302, the first user 301 may utilize the second and third user devices 306, 310 to transmit signals to access various online services and content. The second user device 306 may include a memory 307 that includes instructions, and a processor 308 that executes the instructions from the memory 307 to perform the various operations that are performed by the second user device 306. In certain embodiments, the processor 308 may be hardware, software, or a combination thereof. The second user device 306 may also include an interface 309 that may enable the first user 301 to interact with various applications executing on the second user device 306 and to interact with the system 300. In certain embodiments, the second user device 306 may include any number of transducers, such as, but not limited to, microphones, speakers, any type of audio-based transducer, any type of transducer, or a combination thereof. In certain embodiments, the second user device 306 may be and/or may include a computer, any type of sensor, a laptop, a set-top-box, a tablet device, a phablet, a server, a mobile device, a smartphone, a smart watch, and/or any other type of computing device. Illustratively, the second user device 302 is shown as a smart watch device in FIG. 3.

The third user device 310 may include a memory 311 that includes instructions, and a processor 312 that executes the instructions from the memory 311 to perform the various operations that are performed by the third user device 310. In certain embodiments, the processor 312 may be hardware, software, or a combination thereof. The third user device 310 may also include an interface 313 that may enable the first user 301 to interact with various applications executing on the second user device 306 and to interact with the system 300. In certain embodiments, the third user device 310 may include any number of transducers, such as, but not limited to, microphones, speakers, any type of audio-based transducer, any type of transducer, or a combination thereof. In certain embodiments, the third user device 310 may be and/or may include a computer, any type of sensor, a laptop, a set-top-box, a tablet device, a phablet, a server, a mobile device, a smartphone, a smart watch, and/or any other type of computing device. Illustratively, the third user device 310 is shown as a smart watch device in FIG. 3.

The first, second, and/or third user devices 302, 306, 330 may belong to and/or form a communications network 316. In certain embodiments, the communications network 316 may be a local, mesh, or other network that facilitates communications among the first, second, and/or third user devices 302, 306, 310 and/or any other devices, programs, and/or networks of system 300 or outside system 300. In certain embodiments, the communications network 316 may be formed between the first, second, and third user devices 302, 306, 310 through the use of any type of wireless or other protocol and/or technology. For example, the first, second, and third user devices 302, 306, 310 may communicate with one another in the communications network 316, such as by utilizing Bluetooth Low Energy (BLE), classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 316 may be configured to communicatively link with and/or communicate with any other network of the system 300 and/or outside the system 300.

The system 300 may also include an earphone device 315, which the first user 301 may utilize to hear and/or audition audio content, transmit audio content, receive audio content, experience any type of content, process audio content, adjust audio content, store audio content, perform any type of operation with respect to audio content, or a combination thereof. The earphone device 315 may be an earpiece, a hearing aid, an ear monitor, an ear terminal, a behind-the-ear device, any type of acoustic device, or a combination thereof. The earphone device 315 may include any type of component utilized for any type of earpiece. In certain embodiments, the earphone device 315 may include any number of ambient sound microphones that may be configured to capture and/or measure ambient sounds and/or audio content occurring in an environment that the earphone device 315 is present in and/or is proximate to. In certain embodiments, the ambient sound microphones may be placed at a location or locations on the earphone device 315 that are conducive to capturing and measuring ambient sounds occurring in the environment. For example, the ambient sound microphones may be positioned in proximity to a distal end (e.g.

the end of the earphone device 315 that is not inserted into the first user's 301 ear) of the earphone device 315 such that the ambient sound microphones are in an optimal position to capture ambient or other sounds occurring in the environment. In certain embodiments, the earphone device 315 may include any number of ear canal microphones, which may be configured to capture and/or measure sounds occurring in an ear canal of the first user 301 or other user wearing the earphone device 315. In certain embodiments, the ear canal microphones may be positioned in proximity to a proximal end (e.g. the end of the earphone device 315 that is inserted into the first user's 301 ear) of the earphone device 315 such that sounds occurring in the ear canal of the first user 301 may be captured more readily.

The earphone device 315 may also include any number of transceivers, which may be configured transmit signals to and/or receive signals from any of the devices in the system 300. In certain embodiments, a transceiver of the earphone device 315 may facilitate wireless connections and/or transmissions between the earphone device 315 and any device in the system 300, such as, but not limited to, the first user device 302, the second user device 306, the third user device 310, the fourth user device 321, the fifth user device 325, the earphone device 330, the servers 340, 345, 350, 360, and the database 355. The earphone device 315 may also include any number of memories for storing content and/or instructions, processors that execute the instructions from the memories to perform the operations for the earphone device 315, and/or any type integrated circuit for facilitating the operation of the earphone device 315. In certain embodiments, the processors may comprise, hardware, software, or a combination of hardware and software. The earphone device 315 may also include one or more ear canal receivers, which may be speakers for outputting sound into the ear canal of the first user 301. The ear canal receivers may output sounds obtained via the ear canal microphones, ambient sound microphones, any of the devices in the system 300, from a storage device of the earphone device 315, or any combination thereof.

The ear canal receivers, ear canal microphones, transceivers, memories, processors, integrated circuits, and/or ear canal receivers may be affixed to an electronics package that includes a flexible electronics board. The earphone device 315 may include an electronics packaging housing that may house the ambient sound microphones, ear canal microphones, ear canal receivers (i.e., speakers), electronics supporting the functionality of the microphones and/or receivers, transceivers for receiving and/or transmitting signals, power sources (e.g., batteries and the like), any circuitry facilitating the operation of the earphone device 315, or any combination thereof. The electronics package including the flexible electronics board may be housed within the electronics packaging housing to form an electronics packaging unit. The earphone device 315 may further include an earphone housing, which may include receptacles, openings, and/or keyed recesses for connecting the earphone housing to the electronics packaging housing and/or the electronics package. For example, nozzles of the electronics packaging housing may be inserted into one or more keyed recesses of the earphone housing so as to connect and secure the earphone housing to the electronics packaging housing. When the earphone housing is connected to the electronics packaging housing, the combination of the earphone housing and the electronics packaging housing may form the earphone device 315. The earphone device 315 may further include a cap for securing the electronics packaging housing, the earphone housing, and the electronics package together to form the earphone device 315.

The LTM method can also be used for earphones, earpieces, in-ear devices, hearing aids and other devices where a seal determination is desired). What follows is a discussion of an earphone which is equally applicable to other in-ear devices. In certain embodiments, the earphone device 315 may be configured to have any number of changeable tips, which may be utilized to facilitate the insertion of the earphone device 315 into an ear aperture of an ear of the first user 301, secure the earphone device 315 within the ear canal of an ear of the first user 301, and/or to isolate sound within the ear canal of the first user 301. The tips may be foam tips, which may be affixed onto an end of the earphone housing of the earphone device 315, such as onto a stent and/or attachment mechanism of the earphone housing. In certain embodiments, the tips may be any type of eartip as disclosed and described in the present disclosure. The eartips as disclosed in the present disclosure may be configured to facilitate distributed reduced contact force, sound isolation for sound in the ear canal of the first user 301 (i.e. between the ambient environment and the ear canal environment within an ear of the first user 301), mold into a variety of forms and/or positions, encapsulate volumes upon insertion into an ear aperture of the first user 301, have a pressure adjusting design, facilitate notched stent retention (i.e. on a stent of the earphone housing), facilitate stent insertion into an ear canal of the first user 301 via an ear aperture of the first user 301, or any combination thereof. In certain embodiments, the eartip may be designed to provide sound isolation capability that is at least as effective as conventional foam and/or flange tips. Notably, the LTM headphone may be manufactured and configured to be made in any desired size specifications and/or materials, and may be tailored to each individual user, such as first user 301. In contrast to conventional foam or flange tips, an eartip according to the present disclosure may be adjusted for size without having to substitute the eartip with another eartip, may have an EPA NRR rating of NRR=18, may have a unique flatter high frequency attenuation profile so as to maintain audio quality, may have ease of manufacturability, and may be designed to distribute contact force and minimize radial force against a user's ear canal walls when positioned in a user's ear canal. Additionally, an eartip according to the present disclosure may be made of a non-porous material that is not closed cell foam or open cell foam.

In certain embodiments, the stent of the eartip, over which the eartip is placed, may be designed to have a smaller diameter front end and a larger diameter middle section to promote retention of the eartip on the stent itself. In certain embodiments, a portion of the eartip may have an inner core diameter that is smaller than the stent outer diameter so that the eartip provides radial compression upon the stent so as to enhance sealing and to add friction to prevent axial slippage within the ear canal of the first user 301. In certain embodiments, an increased mid-section inner core diameter of the eartip may be utilized (i.e., larger than the smaller inner core diameter of the eartip), which may be configured to line up with the mid-section outer diameter of the stent of the earphone housing of the earphone device 315. This may provide axial stability for the earphone device 315, while simultaneously preventing axial slippage from the ear canal of the first user 301. In certain embodiments, the eartip may have an insertion end that has a funnel shape, which aids in inserting the eartip onto the stent of the earphone housing of the earphone device 315.

In certain embodiments, the eartip has a configuration that applies minimal force against the first user's 301 ear canal. Additionally, the eartip can seal the first user's 301 ear canal by providing at least 15 dB of attenuation across frequency. To facilitate manufacturability, the eartip may be molded inverted, thereby allowing inexpensive mass production. Lips of the eartip may then be folded to contact ledges to for the eartip that may be utilized by the first user 301. Sealing and comfort depend upon an accurate fit within the first user's 301 ear canal, and, as a result, eartip according to the present disclosure may be manufactured in several single sizes. Notably, any of the features of any of the LTM headphone described in the present disclosure may be combined and/or interchanged with any other LTM headphone components described in the present disclosure. Furthermore, the shape, size, features and/or functionality of any of the components of the earphone device and/or hearbud housing device described in the present disclosure may be modified for each particular user for the shape and size of each user's ear aperture and/or ear canal, or a combination thereof.

In addition to the first user 301, the system 300 may include a second user 320, who may utilize a fourth user device 321 to access data, content, and applications, or to perform a variety of other tasks and functions. Much like the first user 301, the second user 320 may be may be any type of user that may potentially desire to listen to audio content, such as from, but not limited to, a storage device of the fourth user device 321, a telephone call that the second user 320 is participating in, audio content occurring in an environment in proximity to the second user 320, any other type of audio content, or a combination thereof. For example, the second user 320 may be an individual that may be listening to songs stored in a playlist that resides on the fourth user device 321. Also, much like the first user 301, the second user 320 may utilize fourth user device 321 to access an application (e.g. a browser or a mobile application) executing on the fourth user device 321 that may be utilized to access web pages, data, and content associated with the system 300. The fourth user device 321 may include a memory 322 that includes instructions, and a processor 323 that executes the instructions from the memory 322 to perform the various operations that are performed by the fourth user device 321. In certain embodiments, the processor 323 may be hardware, software, or a combination thereof. The fourth user device 321 may also include an interface 324 (e.g. a screen, a monitor, a graphical user interface, etc.) that may enable the second user 320 to interact with various applications executing on the fourth user device 321, to interact with various applications executing in the system 300, and to interact with the system 300. In certain embodiments, the fourth user device 321 may include any number of transducers, such as, but not limited to, microphones, speakers, any type of audio-based transducer, any type of transducer, or a combination thereof. In certain embodiments, the fourth user device 321 or any device may be a computer, a laptop, a tablet device, a phablet, a server, a mobile device, a smartphone, a smart watch, and/or any other type of computing device. Illustratively, the fourth user device 321 may be a computing device in FIG. 3. The fourth user device 321 may also include any of the componentry described for first user device 302, the second user device 306, and/or the third user device 310. In certain embodiments, the fourth user device 321 may also include a global positioning system (GPS), which may include a GPS receiver and any other necessary components for enabling GPS functionality, accelerometers, gyroscopes, sensors, and any other componentry suitable for a computing device.

In addition to using fourth user device 321, the second user 320 may also utilize and/or have access to a fifth user device 325. As with fourth user device 321, the second user 320 may utilize the fourth and fifth user devices 321, 325 to transmit signals to access various online services and content. The fifth user device 325 may include a memory 326 that includes instructions, and a processor 327 that executes the instructions from the memory 326 to perform the various operations that are performed by the fifth user device 325. In certain embodiments, the processor 327 may be hardware, software, or a combination thereof. The fifth user device 325 may also include an interface 328 that may enable the second user 320 to interact with various applications executing on the fifth user device 325 and to interact with the system 300. In certain embodiments, the fifth user device 325 may include any number of transducers, such as, but not limited to, microphones, speakers, any type of audio-based transducer, any type of transducer, or a combination thereof. In certain embodiments, the fifth user device 325 may be and/or may include a computer, any type of sensor, a laptop, a set-top-box, a tablet device, a phablet, a server, a mobile device, a smartphone, a smart watch, and/or any other type of computing device. Illustratively, the fifth user device 325 is shown as a tablet device in FIG. 3.

The fourth and fifth user devices 321, 325 may belong to and/or form a communications network 331. In certain embodiments, the communications network 331 may be a local, mesh, or other network that facilitates communications between the fourth and fifth user devices 321, 325, and/or any other devices, programs, and/or networks of system 300 or outside system 300. In certain embodiments, the communications network 331 may be formed between the fourth and fifth user devices 321, 325 through the use of any type of wireless or other protocol and/or technology. For example, the fourth and fifth user devices 321, 325 may communicate with one another in the communications network 316, such as by utilizing BLE, classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 331 may be configured to communicatively link with and/or communicate with any other network of the system 300 and/or outside the system 300.

Much like first user 301, the second user 320 may have his or her own earphone device 330. The earphone device 330 may be utilized by the second user 320 to hear and/or audition audio content, transmit audio content, receive audio content, experience any type of content, process audio content, adjust audio content, store audio content, perform any type of operation with respect to audio content, or a combination thereof. The earphone device 330 may be an earpiece, a hearing aid, an ear monitor, an ear terminal, a behind-the-ear device, any type of acoustic device, or a combination thereof. The earphone device 330 may include any type of component utilized for any type of earpiece, and may include any of the features, functionality and/or components described and/or usable with earphone device 315. For example, earphone device 330 may include any number of transceivers, ear canal microphones, ambient sound microphones, processors, memories, housings, eartips, foam tips, flanges, any other component, or any combination thereof.

In certain embodiments, the first, second, third, fourth, and/or fifth user devices 302, 306, 310, 321, 325 and/or earphone devices 315, 330 may have any number of software applications and/or application services stored and/or accessible thereon. For example, the first and second user devices 302, 311 may include applications for processing audio content, applications for playing, editing, transmitting, and/or receiving audio content, streaming media applications, speech-to-text translation applications, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 301, 320 to readily interact with the software applications. The software applications and services may also be utilized by the first and second users 301, 320 to interact with any device in the system 300, any network in the system 300 (e.g. communications networks 316, 331, 335), or any combination thereof. For example, the software applications executing on the first, second, third, fourth, and/or fifth user devices 302, 306, 310, 321, 325 and/or earphone devices 315, 330 may be applications for receiving data, applications for storing data, applications for auditioning, editing, storing and/or processing audio content, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first, second, third, fourth, and/or fifth user devices 302, 306, 310, 321, 325 and/or earphone devices 315, 330 may include associated telephone numbers, internet protocol addresses, device identities, or any other identifiers to uniquely identify the first, second, third, fourth, and/or fifth user devices 302, 306, 310, 321, 325 and/or earphone devices 315, 330 and/or the first and second users 301, 320. In certain embodiments, location information corresponding to the first, second, third, fourth, and/or fifth user devices 302, 306, 310, 321, 325 and/or earphone devices 315, 330 may be obtained based on the internet protocol addresses, by receiving a signal from the first, second, third, fourth, and/or fifth user devices 302, 306, 310, 321, 325 and/or earphone devices 315, 330 or based on profile information corresponding to the first, second, third, fourth, and/or fifth user devices 302, 306, 310, 321, 325 and/or earphone devices 315, 330.

The system 300 may also include a communications network 335. The communications network 335 may be under the control of a service provider, the first and/or second users 301, 320, any other designated user, or a combination thereof. The communications network 335 of the system 300 may be configured to link each of the devices in the system 300 to one another. For example, the communications network 335 may be utilized by the first user device 302 to connect with other devices within or outside communications network 335. Additionally, the communications network 335 may be configured to transmit, generate, and receive any information and data traversing the system 300. In certain embodiments, the communications network 335 may include any number of servers, databases, or other componentry. The communications network 335 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 340, 345, and 350 are shown as being included within communications network 335. In certain embodiments, the communications network 335 may be part of a single autonomous system that is located in a particular geographic region, or be part of multiple autonomous systems that span several geographic regions.

Notably, the functionality of the system 300 may be supported and executed by using any combination of the servers 340, 345, 350, and 360. The servers 340, 345, and 350 may reside in communications network 335, however, in certain embodiments, the servers 340, 345, 350 may reside outside communications network 335. The servers 340, 345, and 350 may provide and serve as a server service that performs the various operations and functions provided by the system 300. In certain embodiments, the server 340 may include a memory 341 that includes instructions, and a processor 342 that executes the instructions from the memory 341 to perform various operations that are performed by the server 340. The processor 342 may be hardware, software, or a combination thereof. Similarly, the server 345 may include a memory 346 that includes instructions, and a processor 347 that executes the instructions from the memory 346 to perform the various operations that are performed by the server 345. Furthermore, the server 350 may include a memory 351 that includes instructions, and a processor 352 that executes the instructions from the memory 351 to perform the various operations that are performed by the server 350. In certain embodiments, the servers 340, 345, 350, and 360 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 340, 345, 350 may be communicatively linked to the communications network 335, the communications network 316, the communications network 331, any network, any device in the system 300, any program in the system 300, or any combination thereof.

The database 355 of the system 300 may be utilized to store and relay information that traverses the system 300, cache content that traverses the system 300, store data about each of the devices in the system 300 and perform any other typical functions of a database. In certain embodiments, the database 355 may be connected to or reside within the communications network 335, the communications network 316, the communications network 331, any other network, or a combination thereof. In certain embodiments, the database 355 may serve as a central repository for any information associated with any of the devices and information associated with the system 300. Furthermore, the database 355 may include a processor and memory or be connected to a processor and memory to perform the various operation associated with the database 355. In certain embodiments, the database 355 may be connected to the earphone devices 315, 330, the servers 340, 345, 350, 360, the first user device 302, the second user device 306, the third user device 310, the fourth user device 321, the fifth user device 325, any devices in the system 300, any other device, any network, or any combination thereof.

The database 355 may also store information and metadata obtained from the system 300, store metadata and other information associated with the first and second users 301, 320, store user profiles associated with the first and second users 301, 320, store device profiles associated with any device in the system 300, store communications traversing the system 300, store user preferences, store information associated with any device or signal in the system 300, store information relating to patterns of usage relating to the first, second, third, fourth, and fifth user devices 302, 306, 310, 321, 325, store audio content associated with the first, second, third, fourth, and fifth user devices 302, 306, 310, 321, 325 and/or earphone devices 315, 330, store audio content and/or information associated with the audio content that is captured by the ambient sound microphones, store audio content and/or information associated with audio content that is captured by ear canal microphones, store any information obtained from any of the networks in the system 300, store audio content and/or information associated with audio content that is outputted by ear canal receivers of the system 300, store any information and/or signals transmitted and/or received by transceivers of the system 300, store any device and/or capability specifications relating to the earphone devices 315, 330, store historical data associated with the first and second users 301, 315, store information relating to the size (e.g. depth, height, width, curvatures, etc.) and/or shape of the first and/or second user's 301, 320 ear canals and/or ears, store information identifying and or describing any eartip utilized with the earphone devices 301, 315, store device characteristics for any of the devices in the system 300, store information relating to any devices associated with the first and second users 301, 320, store any information associated with the earphone devices 315, 330, store log on sequences and/or authentication information for accessing any of the devices of the system 300, store information associated with the communications networks 316, 331, store any information generated and/or processed by the system 300, store any of the information disclosed for any of the operations and functions disclosed for the system 300 herewith, store any information traversing the system 300, or any combination thereof. Furthermore, the database 355 may be configured to process queries sent to it by any device in the system 300.

The system 300 may also include a software application, which may be configured to perform and support the operative functions of the system 300, such as the operative functions of the first, second, third, fourth, and fifth user devices 302, 306, 310, 321, 325 and/or the earphone devices 315, 330. In certain embodiments, the application may be a website, a mobile application, a software application, or a combination thereof, which may be made accessible to users utilizing one or more computing devices, such as the first, second, third, fourth, and fifth user devices 302, 306, 310, 321, 325 and/or the earphone devices 315, 330. The application of the system 300 may be accessible via an internet connection established with a browser program or other application executing on the first, second, third, fourth, and fifth user devices 302, 306, 310, 321, 325 and/or the earphone devices 315, 330, a mobile application executing on the first, second, third, fourth, and fifth user devices 302, 306, 310, 321, 325 and/or the earphone devices 315, 330, or through other suitable means. Additionally, the application may allow users and computing devices to create accounts with the application and sign-in to the created accounts with authenticating username and password log-in combinations. The application may include a custom graphical user interface that the first user 301 or second user 320 may interact with by utilizing a browser executing on the first, second, third, fourth, and fifth user devices 302, 306, 310, 321, 325 and/or the earphone devices 315, 330. In certain embodiments, the software application may execute directly as an installed program on the first, second, third, fourth, and fifth user devices 302, 306, 310, 321, 325 and/or the earphone devices 315, 330.

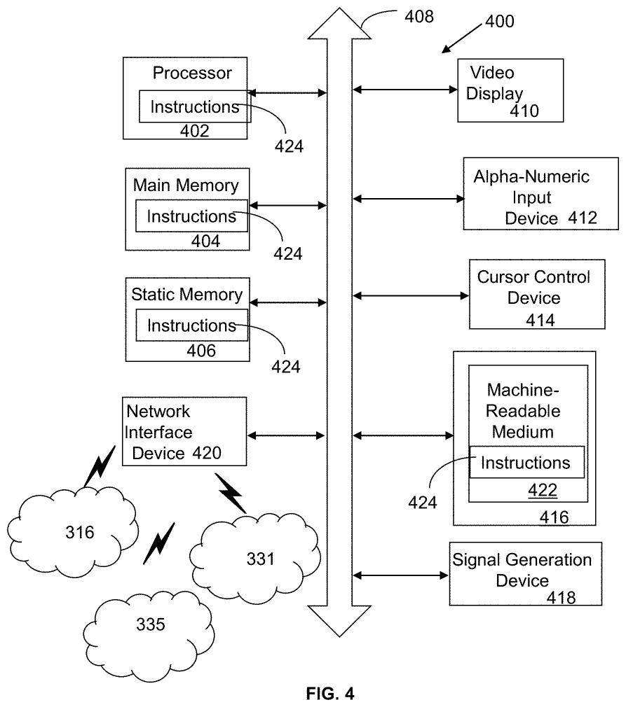

Referring now also to FIG. 4, at least a portion of the methodologies and techniques described with respect to the exemplary embodiments of the system 400 can incorporate a machine, such as, but not limited to, computer system 400, or other computing device within which a set of instructions, when executed, may cause the machine to perform any one or more of the methodologies or functions discussed above. The machine may be configured to facilitate various operations conducted by the system 400. For example, the machine may be configured to, but is not limited to, assist the system 400 by providing processing power to assist with processing loads experienced in the system 400, by providing storage capacity for storing instructions or data traversing the system 400, by providing functionality and/or programs for facilitating the operative functionality of the earphone devices 315, 330, and/or the first, second, third, fourth, and fifth user devices 302, 306, 310, 321, 325 and/or the earphone devices 315, 330, by providing functionality and/or programs for facilitating operation of any of the components of the earphone devices 315, 330 (e.g. ear canal receivers, transceivers, ear canal microphones, ambient sound microphones, or by assisting with any other operations conducted by or within the system 400.

In some embodiments, the machine may operate as a standalone device. In some embodiments, the machine may be connected (e.g., using communications network 335, the communications network 316, the communications network 331, another network, or a combination thereof) to and assist with operations performed by other machines and systems, such as, but not limited to, the first user device 302, the second user device 311, the third user device 310, the fourth user device 321, the fifth user device 325, the earphone device 315, the earphone device 330, the server 340, the server 350, the database 355, the server 360, or any combination thereof. The machine may be connected with any component in the system 400. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410, which may be, but is not limited to, a liquid crystal display (LCD), a flat panel, a solid state display, or a cathode ray tube (CRT). The computer system 400 may include an input device 412, such as, but not limited to, a keyboard, a cursor control device 414, such as, but not limited to, a mouse, a disk drive unit 416, a signal generation device 418, such as, but not limited to, a speaker or remote control, and a network interface device 420.

The disk drive unit 416 may include a machine-readable medium 422 on which is stored one or more sets of instructions 424, such as, but not limited to, software embodying any one or more of the methodologies or functions described herein, including those methods illustrated above. The instructions 424 may also reside, completely or at least partially, within the main memory 404, the static memory 406, or within the processor 402, or a combination thereof, during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 422 containing instructions 424 so that a device connected to the communications network 335, the communications network 316, the communications network 331, another network, or a combination thereof, can send or receive voice, video or data, and communicate over the communications network 335, the communications network 316, the communications network 331, another network, or a combination thereof, using the instructions. The instructions 424 may further be transmitted or received over the communications network 335, another network, or a combination thereof, via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The Earplug Fit-Test System (also referred to as LTM headphone or headset, or LTM muff if one cup is being referred to), comprised of an earmuff-based headphone device, the Leak Test Method Headphone, with an internal microphone and speaker that fits above the inserted earplug, provides a rapid fit/leak test (e.g., in just seconds), and also provides the functionality of performing a Field-REAT (FREAT) test on each individual. HEAR's innovative Leak-Test Method (LTM) uses an internal microphone to measure test signals comparing an unoccluded ear's acoustic spectrum to a ‘supposed’ occluded ear's acoustic spectrum to determine if a leak exists. The LTM process is the first test stage (Stage 1) and takes only seconds to yield a result, which will be indicative of whether an earplug seal leak of predetermined criterion is apparent, or not. If the LTM indicates a poor seal then the LTM Headphone is removed, the user repositions the inserted earplug or chooses a different one, reinserts, refits the LTM Headphone, then tests again using the rapid LTM feature, repeating the process until a good seal (e.g., an indication of a seal >10 dB) is indicated in each ear (since the test is performed bilaterally). When the LTM indicates a good seal, then Stage 2, a Field Real-Ear-Attenuation-at-Threshold Test (FREAT), is performed with the LTM Headphone, which is left in place over the earplug, testing up to 7 selectable frequencies. Then the data are fed to the LTM Earplug Fit-Test System control tablet/phone, and the current PAR value is calculated with a selection of 3, 5, or 7 frequencies.

There are several advantages to the LTM Earplug Fit-Test System, in that it: (1) can accommodate all premolded, user-molded (foam, gel, putty, fibrous), and custom-molded earplugs as well as canal caps under the large volume LTM Headphone, (2) does not use a modified (i.e., “surrogate”) earplug (e.g., a tube or probe microphone through a standard earplug) as needed in a MIRE-based fit-test system, (3) is rapid (a few seconds for the LTM), (4) is sequential (i.e., 2 discrete stages of testing) and efficient (i.e., if the earplug fails the LTM stage, an alternative earplug can be substituted before the more lengthy FREAT test stage is performed), (5) can be used by many persons (i.e., the system can be worn by anyone that can wear an earmuff), and since each user has his/her own stand-alone LAT Headphone controlled by tablet or smartphone, multiple users can be tested simultaneously, (6) is rugged and portable (the battery-operated LTM Headphone that connects to a phone or computer tablet as envisioned in Phase II with at least 4-hour battery life), (7) is designed for various climate conditions, (8) conducts tests at selectable, multiple frequencies (i.e., designed to employ 3, 5, or 7 frequencies [or 9 as option] for the FREAT feature), (9) has both wired and wireless connection alternative, and (10) via its automatic gain control feedback loop on the FREAT test, can be used in a variety of background noise settings from the field, barracks, and clinics.

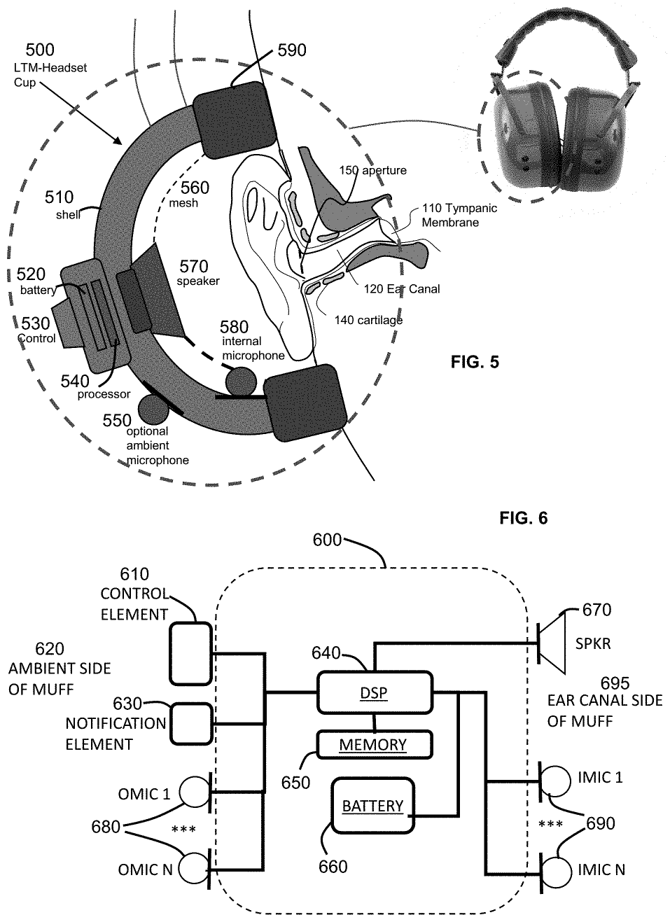

FIG. 5 illustrates the components of an LTM Muff 500 of the an LTM headphone, including an internal speaker 570, an internal microphone 580, an optional external ambient sound pickup microphone 550 (for the automatic gain control adjustment), a processor 540, a user interface (control) 530 and a battery 520. The LTM muff 500 can also include an inner mesh 560. The speaker 570 can play an audio content signal that includes an earfit test signal. The initiation of the earfit test signal can occur using the control 530, automatically or even in response to voice commands.

FIG. 6 illustrates a circuit summary 600 of at least one exemplary embodiment of an LTM muff. In general, there are two sides of the LTM Muff, an ambient side 620 and an ear canal side 695. The ear canal side 695, can include a speaker 670, and at least one interior microphone (IMIC) 690. The ambient side 620, can include a control element 610, a notification element 630, and at least one outside microphone (OMIC) 680. The OMICs 680, IMICs 690, notification element 630, control element 610, can send signals to the processor 640 (e.g., DSP). The DSP can store data into a buffer (e.g., circular) in memory 650. Power can be wired or a battery 660.

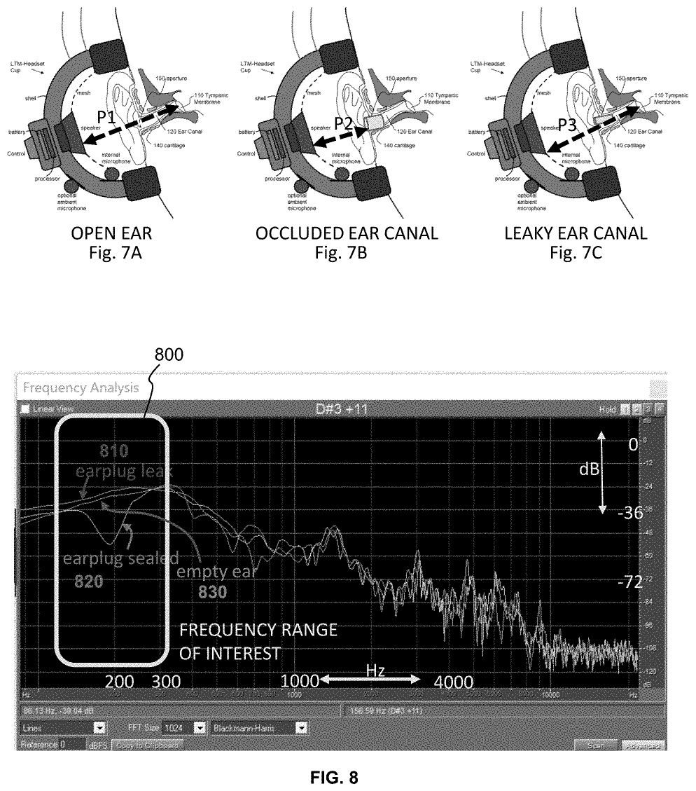

FIGS. 7A, 7B and 7C illustrates using the LTM muff to play audio content into an open ear (FIG. 7A), into a sealed ear (FIG. 7B), and into a leaky earplug system (FIG. 7C). The path length, L, can change from the speaker to the reflection point (e.g., earplug, tympanic membrane), for example P1, P2, and P3 in FIGS. 7A, 7B, and 7C respectively. The period (T) and the resonance frequency fr, are related to the path length L, and the speed of an acoustic wave c, and can be expressed as:

$$T = \frac{2 L}{c} \qquad ( 1 )$$

$${f}_{r} = \frac{c}{2 L} \qquad ( 2 )$$

If the Muff is sealed (path length L=P2), then the resonance frequency, fr, will be prominent in any FFT of a microphone signal picked up by an inner microphone (e.g., 580) when a signal is played into the sealed cavity. The resonant frequency will change as the path length L changes, for example L goes from P2 to P1 or P3. The path length L changes when the earplug/earpiece seals the ear canal such that L is now from the speaker of the muff to the earplug/earphone (e.g., L=P2). As L decreases (e.g., from P1 to P2) the resonant frequency shifts to a higher value. For example, if the unsealed L is P1=50 mm and c=343 m/sec, fr is 3430 Hz. If an earplug seals the ear canal such that the path length L=P2=25 mm, then fr becomes 6860 Hz. The relative, spectral amplitudes (e.g., can be intensities based upon pressure, energy), A, of the two frequencies can determine leaks. For example, for a fully unoccluded ear canal the ratio R=A(3430 Hz)/A(6860 Hz)>first threshold can indicate unoccluded. A ratio R=A(3430 Hz)/A(6860 Hz)<second threshold can indicate full seal. A ratio value between, second threshold<R<first threshold can indicate various levels of leaking. Note that the discussion herein is not intended to limit the method of determining a seal or leak, for example the ratio could be R=A(6860 Hz)/A(3430 Hz Hz), or differences can be used and the difference D used instead for example D=A(6860 Hz)-A(3430 Hz) with different thresholds can be used. Additionally, correlations, coherences, cross-correlations can be used between a microphone signal of predetermined unoccluded and a microphone signal measured in real time with an earplug inserted. Additionally, a user can be asked to take a measurement without the earplug inserted, then with the earplug inserted and the two relative microphone signals (the first with no earplug and the second with the earplug inserted) can be compared (e.g., as discussed above with respect to ratios, differences, coherence, correlation, cross-correlation). A visual and/or audible warning can be provided to indicate the level of seal, for example from “full seal”, “leaky”, or “unoccluded”. Other synonyms are intended, for example “poor seal”, “good seal” and so on. Even visual level display.

In addition to the resonant frequencies, integer fractions (n) of the resonant frequencies fm, can also be used, where an integer fraction of the resonant frequency, fm, can be expressed as:

$${f}_{rn} = \frac{c}{2 L n} \qquad ( 3 )$$

The integer fraction of the resonant frequency, frn, can show up in any spectral analysis of a microphone signal. This results from there being a difficulty in a microphone distinguishing between an acoustic wave travelling a longer path length of Ln compared to L. Thus, reflected waves travelling a path length of L, that reflect three times (initial reflection, reflection at speaker, then a last at the far end again, e.g., n=2), will be picked up by the microphone as if there was a longer path length of 2 L, resulting in a lower frequency. For example, if sealed and fr=6860 Hz, then fr2=3430. Note that this can cause a complication if the offset between the speaker and the earplug (e.g., P2) is the same as the ear canal depth (e.g. P1-P2), since if the earplug is sealed, an enhancement also occurs at fr2 at 3430 Hz, which can complicate ratio determinations. For example, for the above calculations we assumed the distance between the speaker and earplug was half that of the distance between speaker and tympanic membrane. This can be used to determine the ear canal length by having an adjustable speaker offset distance and look at the offset distance at which the fr2 peaks during the adjustment, this determines that the offset distance between a sealed condition and the speaker is equal to the ear canal length in the unsealed condition. For example, assume a measurement is taken in the occluded case with a set offset of the speaker with a sealed condition. The offset distance is adjusted so that the fr2 in the sealed condition equals fr for the open. This means that the offset distance is very near the ear canal length. Thus, this method can be used to determine the ear canal length by looking at the final offset distance. Note that various methods in the LTM muff can be used to determine the distance from the speaker and a sealed aperture. For example, an inserted ultrasonic emitter and receiver can be used to determine the speaker distance from the ear canal aperture, and can be added as additional inner microphones.

In addition to determining the ear canal lengths as discussed above, the integer fraction resonance frequency's fm, can be used to determine seal as well, although as discussed above the offset distance (e.g., P2) should not be an approximately the actual ear canal length. For example if we assume or determine that the offset distance between the speaker and the sealed condition is not an integer fraction of the actual ear canal length, frn can also be used to determine seal. For example, in a sealed condition, the amplitude at fr2 will increase, where fr in this case is associated with the L associated with an offset distance P2. Thus, the ratio can be R=fr2sealed/fropen-ear, between the peaks and compared to thresholds, or even R=fr2sealed/frsealed, where it is expected that fr2sealed will decrease at a rate different from frsealed if unsealed or leaky. Note you can use other integer fractions (n) also for example R=frn/fr, or even R=frn/fr(n−2) etc. . . . As mentioned, other comparison methods can be used (coherence, correlation, difference, cross-correlation) instead of ratios. Additionally other comparisons between open and sealed measurements.

FIG. 8 illustrates data for the LTM muff data for scenario FIG. 7A (empty ear 830), data for the occluded ear condition as in FIG. 7B (earplug sealed 820), and data for a leaky ear canal as in FIG. 7C.

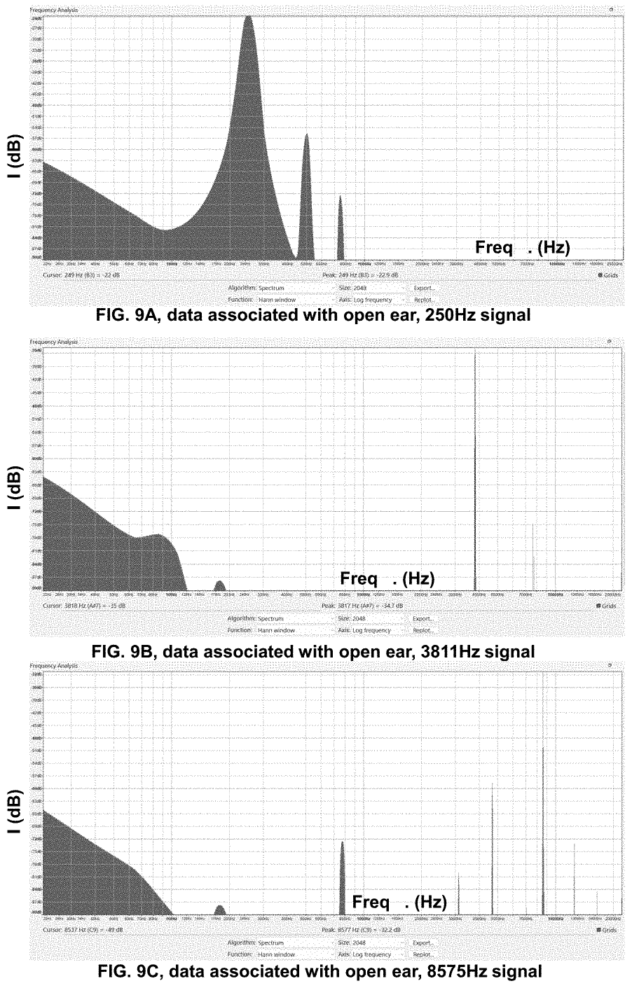

FIGS. 9A, 9B, 9C, 10A, 10B, 10C, 11A, 11B, 11C, 12A, 12B and 12C illustrate sample data from a test fixture experiment where the test fixture ear canal length is 25 mm (P1-P2), and the offset distance is P2=20 mm. FIGS. 9A, 9B, 9C show microphone spectrum data for an open ear condition, for emitted audio frequencies of 250 Hz, 3811 Hz, and 8575 Hz. Where 3811 Hz correspond to the resonance frequency for a path length of L=P1=45 mm and 8575 Hz corresponds to a resonance frequency for a path length equal to the offset distance of L=P2=20 mm. Table 1 illustrates intensity values (dB) at the peaks at 249 Hz, 3817 Hz and 8577 Hz for the various conditions of open ear, sealed, a 1.27 mm ID leak and a 2 mm by 2 mm muff leak.

TABLE 1
Intensity (dB) Data (Closer to 0 is a larger value)
P2 = 20 mm
P1 − P2 = 25 mm

| | | | | sealed earplug |
|---|---|---|---|---|
| | Open | | Leak | with a 2 mm by |
| | Ear | Sealed | 1.27 mmID | 2 mm Muff leak |
| I at 249 Hz | −22.9 | −23.3 | −27.2 | −24 |
| I at 3817 Hz | −34.7 | −30 | −35.9 | −31 |
| I at 8577 Hz | −32.2 | −26.7 | −34.7 | −33 |

Note that the less negative values are larger. Hence −26.7 dB is a larger value than −35.9 dB. To make this clear Table 2 shows the values of table 1 with the values presented as gamma-table 1 values, where gamma is 50.

TABLE 2
Intensity (dB) Data (50 dB + actual data)
P2 = 20 mm
P1 − P2 = 25 mm

| | 50 | | | |
|---|---|---|---|---|
| | | | | sealed earplug |
| | Open | | Leak | with a 2 mm by |
| | Ear | Sealed | 1.27 mmID | 2 mm Muff leak |
| I at 249 Hz | 27.1 | 26.7 | 22.8 | 26 |
| I at 3817 Hz | 15.3 | 20 | 14.1 | 19 |
| I at 8577 Hz | 17.8 | 23.3 | 15.3 | 17 |

Note that as shown in Table 2 the sealed intensity at 8577 Hz shows a larger value than any of the other conditions. Also note that the muff leak has an intensity at 8577 Hz similar to the open ear condition, while maintaining an intensity similar to the sealed condition at an intensity at 3817 Hz.

Table 3 shows various ratios between sealed values and the various other conditions.

TABLE 3
Various Ratios of Table 2 Data

| | Sealed/OE | Sealed/Leak | Sealed/Muffleak |
|---|---|---|---|
| I at 249 Hz | 0.9852399 | 1.171052632 | 1.026923077 |
| I at 3817 Hz | 1.3071895 | 1.418439716 | 1.052631579 |
| I at 8577 Hz | 1.3089888 | 1.522875817 | 1.370588235 |

Note that for a muff leak the ratio of sealed intensity to muff leak condition intensity at 8577 Hz is larger 1.37 than the ratios at 249 Hz and 3817 Hz respectively of 1.02 and 1.05. Whereas the open ear and leak in the earplug conditions have ratios with respect to the sealed condition of 1.30 and 1.41 respectively at 3817 Hz.

Table 4 shows various self ratio values that can also be used. For example notice that the self ratio for Intensity at 249 Hz to 3817 Hz for the earplug leak and open ear are similar at 1.61 and 1.77 respectively, while the same ratio for a sealed earplug without muff leak is 1.33 and with a muff leak is 1.36. Note also that any leak or open ear condition has a ratio of intensities for 249 Hz to 8577 Hz much larger than 1, with values of 1.52 for the open ear, 1.49 for the earplug leak of 1.27 mm inner diameter, and 1.52 for the muff leak of 2 mm by 2 mm, whereas the corresponding ratio for the sealed earplug and no leaky muff condition has a ratio of 1.14. Notice that for purely unobstructed paths (open ear and sealed earplug) the self ratios at frequencies of 3817 Hz to 8577 Hz are 0.85 for open ear and 0.85 for sealed earplug. A leaky earplug has a self ratio for those frequencies of 0.92, while a muff with a much larger leak has a ratio of 1.11.

TABLE 4
Various Self Ratios

| | | | | sealed earplug |
|---|---|---|---|---|
| Intensity | Open | | Leak | with a 2 mm by |
| Ratios | Ear | Sealed | 1.27 mmID | 2 mm Muff leak |
| I249/I3817 | 1.7712418 | 1.335 | 1.617021277 | 1.368421 |
| I249/I8577 | 1.5224719 | 1.145922747 | 1.490196078 | 1.529412 |
| I3817/I8577 | 0.8595506 | 0.858369099 | 0.921568627 | 1.117647 |

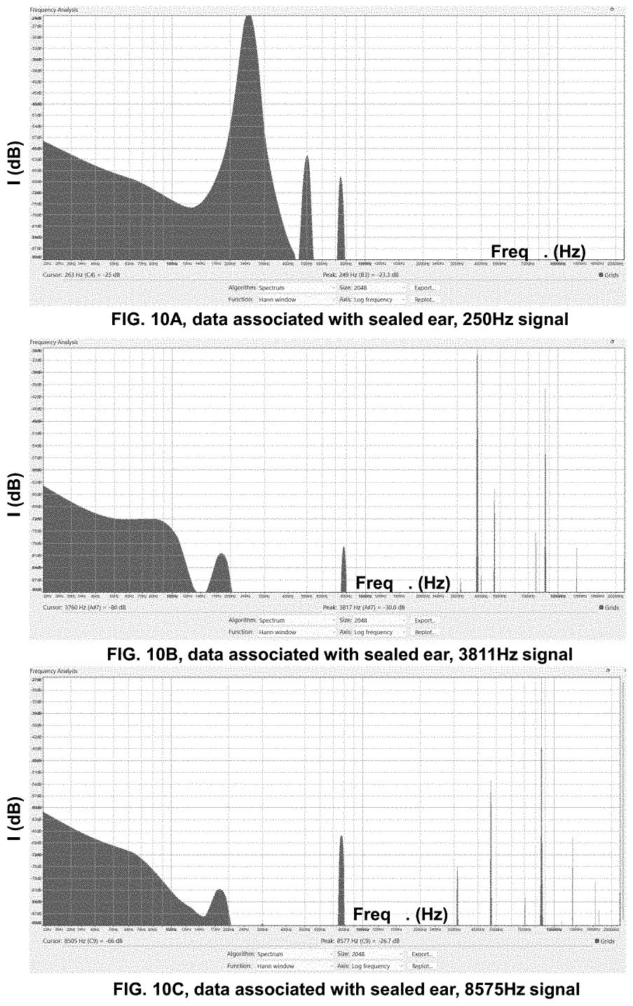

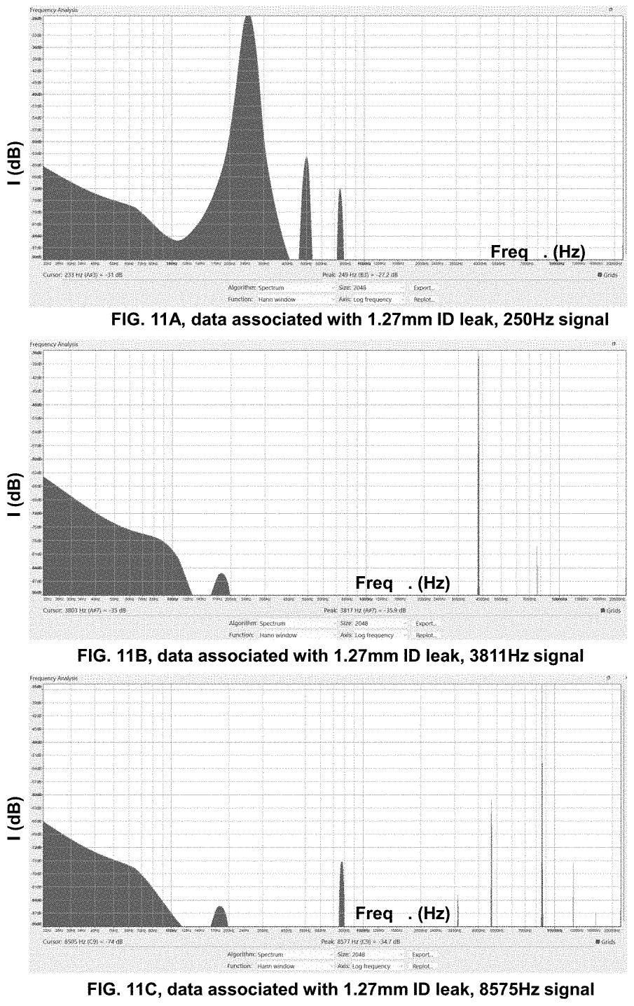

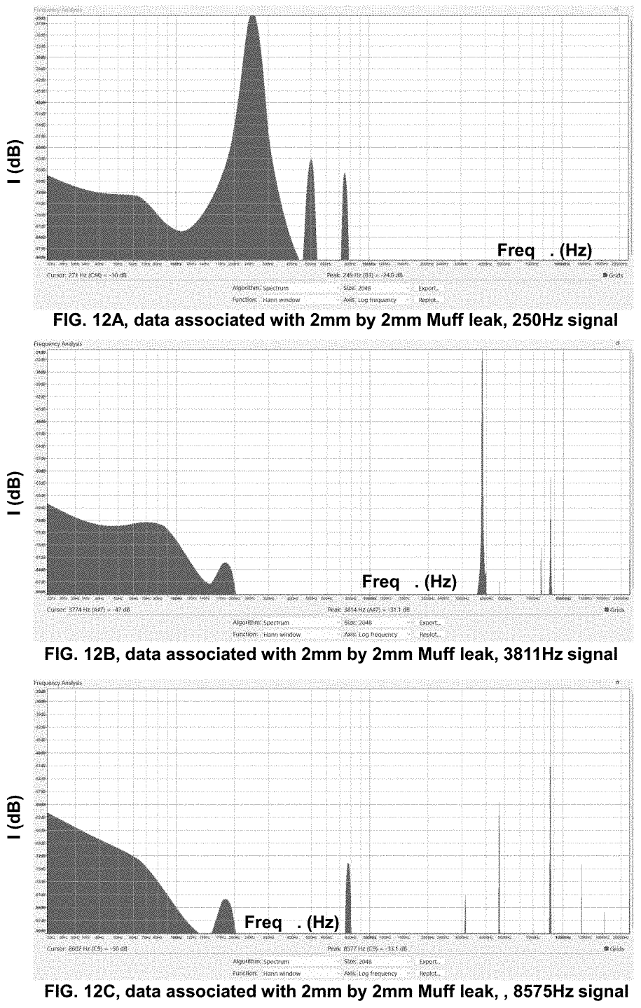

Although ratios have been discussed, again other comparison methods can be used for example comparison with the earfit test signal sent to the speaker, for example using coherence, correlation, and/or cross correlation at various frequencies. FIGS. 9A, 9B, 9C, 10A, 10B, 10C, 11A, 11B, 11C, 12A, 12B, and 12C contain spectral data that can also be used. For example notice that an integer fraction resonance peak occurs at 775 Hz (about n=5) for the emitted 3811 Hz signal for the sealed earplug condition (FIG. 10B) which does not occur anywhere near the same intensity for the open ear condition (FIG. 9B), the leaky earplug condition (FIG. 11B) or the leaky muff condition (FIG. 12B). Note also that for an emitted earfit signal at 250 Hz, the muff condition has an intensity plateau (about −73 dB) near 50 Hz and 60 Hz, while all other conditions have slopes at the same frequencies. Additionally for the 3811 Hz earfit test signal, the spectrum below 200 Hz is different for each condition, for example for a muff leak energy is lost at the lower frequencies (e.g., 25 Hz) compared to the other conditions. Notice also for the 3877 Hz emitted signal, resonance peaks above 3877 Hz generally disappear for the open ear and leaky earplug conditions, but not for the sealed earplug and sealed earplug with a muff leak condition.

In addition to determining whether there is a seal of an earplug/earpiece in an ear canal, or for that matter in determining the seal of any inserted device into a channel (e.g., determining whether a channel is clogged, for example a blood vessel.), multiple inner microphones (e.g., 690) can be spaced along the inside of the muff to determine whether the muff has made a seal with the area around the ear canal. For example, a test signal can be played by the speaker at lower frequencies, e.g., <500 Hz, and the test signal sent to the speaker can be compared to the inner microphone measurements to determine if there is a seal of the muff around the ear canal region. For example, the cross correlation (Xcorr) of the two signals (test signal sent to speaker and a microphone signal from one of the inner microphones 690) can be compared with a threshold value (e.g., <0.5) to determine if the muff is sealed. The advantage of multiple inner microphones is that a comparison of the test signal with each inner microphone signal can be used to determine the approximate location of the leak. For example, if there are 4 inner microphones (e.g., one positioned at a zero angle location, another at 90 degrees, another at 180 degrees and the last at 270 degrees around the muff in a plane parallel to the plane defined by the contact surface of the muff with the head) then the Xcorr values can be used to located which microphone the leak is closest to. For example if the values are Xcorr1=0.2, Xcorr2=0.4, Xcorr3=0.6, and Xcorr 4=0.5, . . . then the leak is closest to inner microphone 1 since Xcorr 1<Xcorr2; Xcorr 1<Xcorr3; and Xcorr 1<Xcorr4. Lights on the back of the muff can light up (e.g. red, orange, green) to indicate where the muff leak is, so that a user can reposition the muff until all are green. Even though discussion above uses the cross-correlation (Xcorr), amplitudes at particular frequencies (e.g., <500 Hz) can be compared as well, or correlation and coherence.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

Note that the stent or other components can be fabricated from various materials (e.g., silicon, urethane, rubber) and can include internal channel (tubes). The stent can also be a multi-lumen (i.e., multi-passageway) stent where the channels/tubes are various lumens of the multi-lumen stent, or solid (e.g., earplug stent). Note that the material of the membrane can have similar or different properties from the stent, and can be composed, as can the stent, of material known by one of ordinary skill in the art of eartip (e.g., flange, foam eartip) manufacturing. Also, the eartip can have a material property between 2 Shore A to 90 Shore A.

Processes, techniques, apparatus, and materials as known by one of ordinary skill in the art may not be discussed in detail but are intended to be part of the enabling description where appropriate. For example, specific materials may not be listed for achieving each of the targeted properties discussed, however one of ordinary skill would be able, without undo experimentation, to determine the materials needed given the enabling disclosure herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. For example, if words such as “orthogonal”, “perpendicular” are used, the intended meaning is “substantially orthogonal” and “substantially perpendicular” respectively. Additionally, although specific numbers may be quoted in the claims, it is intended that a number close to the one stated is also within the intended scope, i.e. any stated number (e.g., 20 mils) should be interpreted to be “about” the value of the stated number (e.g., about 20 mils). Note also that each part of an eartip can be composed of different materials, for example the tip contact portion can be silicone, while the tip support composed of urethane and the stent also silicone or even a different material from the other parts.

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A method comprising:
placing a muff over an ear to form a cavity, wherein an earplug has been inserted into an ear canal of the ear;
checking the seal of the muff;
sending an earfit signal to a speaker of the muff;
generating a microphone signal by measuring the sound in the cavity with a microphone while the earfit signal is played by the speaker;
comparing a characteristic of the microphone signal with reference values to determine if the earplug is sealed; and
sending notification of the status of the seal of the earplug.

2. A device comprising:
a microphone configured to generate a microphone signal;
a speaker configured to emit audio;
memory configured to store instructions; and
a processor configured to execute the instructions to perform operations, the operations comprising:
sending an earfit signal to the speaker, wherein the speaker, in response to the earfit signal, emits audio content into a cavity formed by the device, wherein a boundary of the cavity includes a channel with an inserted obstruction;
receiving the microphone signal, wherein the microphone signal was generated while measuring sound in the cavity while the speaker emitted the audio content;
analyzing the microphone signal to determine if the obstruction seals the channel;
sending a notification of the status of the seal of the obstruction.

3. The device according to claim 2, wherein the status is one of, a good seal, or a poor seal or a combination thereof.
